(19) United States
(12) Patent Application Publication
(10) Pub. No.: US 2009/0053667 A1
(43) Pub. Date: Feb. 26, 2009

(54) System and Device for Identifying Optical Characteristics of a Tooth and Method Used Thereby

(76) Inventor: Ho-Yeh Chen, Taipei City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/843,736

(22) Filed: Aug. 23, 2007

(51) Int. Cl. A61C 3/00

(52) U.S. Cl. 433/29

(57) ABSTRACT

A device for identifying the optical characteristics of a tooth, which comprises a light source for sequentially emitting a plurality of radiations of different wavelengths; an optical conductor for conducting the radiations onto the tooth; a sensor for collecting radiations reflected by the tooth; a comparator for determining whether the intensities of the collected radiations fall within a predefined range; and an indicator for signaling the resulting determination.

### BACKGROUND OF THE INVENTION

1. Field of the Invention

The present invention relates to the detection of the optical characteristics of a tooth and, more particularly, to a device and method for detecting caries and other abnormalities.

2. Description of the Related Art

The detection of caries is a process frequently performed by dentists, who visually compare the colors of teeth to find the carious one(s). Conventionally, the process is highly empirical in that the accuracy thereof is always dependent on the experience and intuition of the dentists. Although caries can be correctly identified in most situations, the traditional approach fails to produce very precise results and is limited by the visual acuity of the dentists. As these dentists age, loss of visual acuity may lead to incorrect identification of caries.

To provide an aid for dentists and to facilitate the detection of caries, several optical instruments have been proposed. In U.S. Pat. No. 6,750,971 to Overbeck et al., an instrument for acquiring an image of a tooth is provided which comprises a sensor, a filter, and a display means; in addition, to establish a reference color and a predetermined distance to a target, the instrument may also be installed with a disposable sanitary shield. Illuminating a tooth with constant irradiation and collecting time-separated frames of different wavelengths of light reflected from a tooth, the instrument enables an operator to view a display of the image on the instrument and to measure the object being viewed.

Another invention, U.S. Pat. No. 2005/0175967 to Karazivan et al., discloses a similar system for the detection of dental root canal apical foramina which mainly comprises three components: a conductor, a collector, and a detection device. By the comparison of the radiation intensities, the system enables users to locate the root canal apical foramen.

Both of the above-mentioned inventions, however, require a filter to filter out undesired radiations and the inclusion of this filter inevitably results in an increase of the volume of the instrument and in greater complexity of the fabrication thereof. In addition, no preferable light source is specified in the documents. Accordingly, there is a need to propose an improvement in dental examination instruments.

### SUMMARY OF THE INVENTION

It is therefore an object of the present invention to provide a novel device for identifying the optical characteristics of a tooth, said device utilizing a light source to sequentially emit a plurality of radiations of different wavelengths. By the provision of multiple radiations of varying wavelengths, this invention may have a broader spectral scope of observation; as a result, the device may be capable of detecting optical characteristics undetectable by the human eye.

More specifically, it is an object of the present invention to provide a dental instrument with an RGB LED as the light source for sequentially emitting radiations of red, green, and blue wavelengths. Since the RGB LED is capable of emitting desirable monochromatic radiations, the device of this invention may work without the necessity of a filter. Furthermore, the adaptation of red, green, and blue lights, also know as the “primary colors,” better simulates the naked-eye observation of a dentist in that these colors are related to the physiology of the human eye; these particular colors are stimuli that maximize the differences between the responses of the cone cells of the human retina to lights of different wavelengths, and that thereby make a large color triangle.

It is another object of the present invention to provide a device for identifying the optical characteristics of a tooth. The device has a sensor for collecting radiations reflected by a tooth. Preferably, the sensor is selected from the group consisting of a photodiode, a hototransistor, a Si-Pin photodiode, a photon multiplexer tube, a photoconductive cell, a multi channel photon counter, and an avalanche photodiode. More preferably, the sensor is a photodiode.

In accordance with the present invention, there is provided a device for identifying the optical characteristics of a tooth, the device comprising a light source for sequentially emitting a plurality of radiations of different wavelengths; an optical conductor for casting the radiations onto the tooth; a sensor for collecting radiation reflected by the tooth; a comparator for determining whether the intensities of the collected radiations fall within a predefined range of wavelengths; and an indicator for signaling the resulting determination.

Also in accordance with the present invention, there is provided a method of identifying the optical characteristics of a tooth, comprising the following steps: irradiating a tooth with a plurality of radiations of different wavelengths sequentially; collecting the resulting radiations reflected by the tooth; determining whether the intensities of the collected radiations fall within a predefined range; and signaling the resulting determination.

Further in accordance with the present invention, there is provided a system for identifying the optical characteristics of a tooth which comprises a light irradiator for sequentially emitting red, green, and blue lights; an optical conductor for bringing the lights onto the tooth; a sensor for collecting radiations reflected by the tooth; a comparator for determining whether the intensities of the collected radiations fall within a predefined range of wavelengths; and an indicator for signaling the resulting determination.

Other objects, advantages, and novel features of the invention will become more apparent from the following detailed description when taken in conjunction with the accompanying drawings.

### BRIEF DESCRIPTION OF THE DRAWINGS

The accompanying drawings, which are included in and constitute a part of this specification, illustrate the embodiments of the invention and, together with the description, explain the features and principles of the invention. In the drawings:

FIG. 1 is an illustrative diagram of the device for identifying optical characteristics of a tooth of the present invention.

FIG. 2 is a flowchart of the method of the present invention.

### DETAILED DESCRIPTION OF THE PREFERRED EMBODIMENT

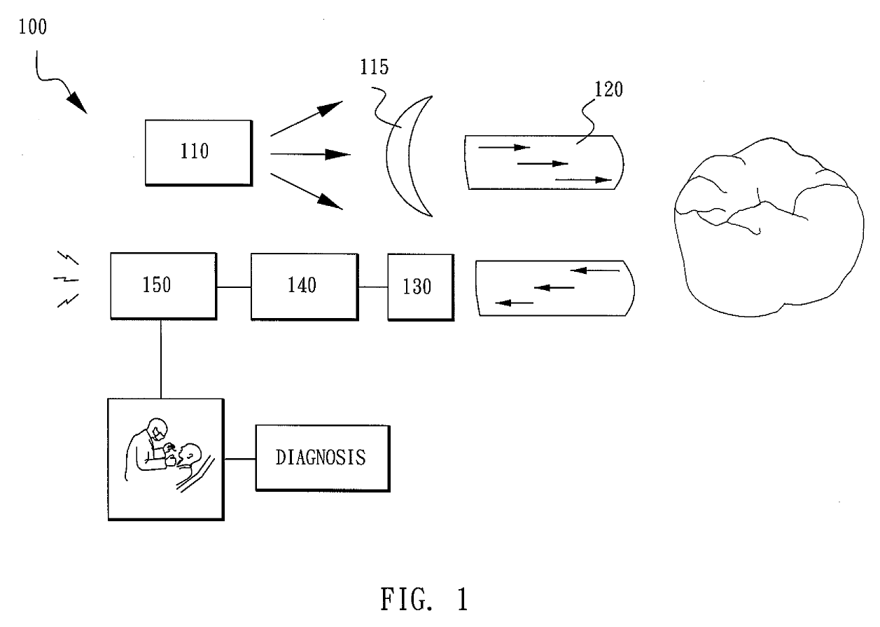

In accordance with the present invention, FIG. 1 illustrates the device for identifying the optical characteristics of a tooth of the present invention. Generally, the device 100 of this invention comprises a light source 110 for sequentially emitting a plurality of radiations of different wavelengths; an optical conductor 120 for conducting the radiations onto the tooth; a sensor 130 for collecting radiations reflected by the tooth; a comparator 140 for determining whether the intensities of the collected radiations fall within a predefined range; and an indicator 150 for signaling the resulting determination.

In this invention, examples of the light source 110 may include LEDs, laser-diodes, devices capable of emitting lasers, halogen lights, or neon lights, or any other suitable radiation emission source. Preferably, the light source 110 of the device 100 is an LED capable of emitting multiple monochromatic lights in a time differentiation manner. More preferably, the light source 110 of the device 100 is an LED capable of emitting multiple monochromatic lights selected from the combination of red light, green light, blue light, infrared, and ultraviolet. For example, the combination of the radiations may be, but is not limited to, red, green, and blue lights; infrared, green light, and blue light; red light, green light, and ultraviolet light; or infrared light, green light, and ultraviolet light. Most preferably, the flight source 110 of the device 100 is an RGB LED which is capable of emitting red, green, and blue lights.

Since the light source 110 emits monochromatic light waves, it is noted that no filter is needed by the present invention.

To focus or collimate the emissions produced by the light source 110, a reflection mask 115 may be provided between the light source 110 and the optical conductor 120.

The optical conductor 120 can be made of any light-guiding material. Preferably, it can be an optical fiber or bundle of optical fibers similar to, for example, some of the optical fibers used for laser-based endodontic treatment, or any other material suitable for the transmission of radiation within the light spectrum. With no limitation, the optical conductor 120 can also be a light guide tube made of PMMA or other equivalent material.

In this embodiment, the radiations that pass through the optical conductor 12 will then be cast onto a tooth of interest. Due to the inherent differences among teeth with various physical properties, the interaction between the radiations and the tooth may vary slightly. For example, a tooth covered by dentine may have an absorption/reflection pattern that is different from that of a tooth covered by enamel. In other words, this invention is principally based the spectroscopic evaluation system of the absorption and/or reflectance spectra of dental structures. Accordingly, the resulting radiations may be applied to an analysis of tooth condition and provide preliminary information by which a dentist may conduct a diagnosis.

As shown in FIG. 1, a sensor 130 is provided for collecting radiations reflected by the tooth. Preferably, the sensor 130 may be any one of the group consisting of a photodiode, a hototransistor, a Si-Pin photodiode, a photon multiplexer tube, a photoconductive cell, a multi channel photon counter, and an avalanche photodiode. More preferably, the sensor may be a photodiode.

As mentioned above, because the light source 110 used in the present invention emits monochromatic light waves, no filter will be needed to filter out light waves of undesirable wavelengths before the collection by the sensor 130.

The sensor 130 of this invention is capable of detecting the physical characteristics of the reflected radiations such as intensities and converting them into electrical signals. The electrical signals of the reflected radiations are then transmitted to a comparator 140 electrically connected thereto. The comparator 140 of this invention may be any device for comparing the received electrical signals with a predefined criterion. For example, it may be a processing chip or other similar electronic device.

In this invention, the radiations of varying wavelengths are emitted in a time differentiation manner; thus, the comparator 140 may differentiate the electrical signals and the corresponding radiations at the time they are received. As a result, the information on the radiations and their properties may be obtained for the determination of whether a certain criterion is met or not.

When the electrical signals corresponding to a tooth fall within a predefined range, it represents that the optical characteristics of the tooth are similar to those of caries. Consequently, the comparator 140 may transmit a signal to an indicator 150 electrically connected to it for the purpose of signaling the resulting determination.

The indicator 150 of the present invention is a signal generator for generating a stimulus to inform the user about the final determination. For example, it may be a sound/illumination generator that emits a sound/light proportional to the intensities of the resulting radiations. Also, it may be an oscillation component for revealing the detection of caries through vibration. Therefore, the detection of caries may be simplified by the use of the device 100 of the present invention. The precision and accuracy of the diagnosis can also be furthered as the device 100 is capable of detecting the optical nuances of a tooth that fall outside the detection range of the human eye.

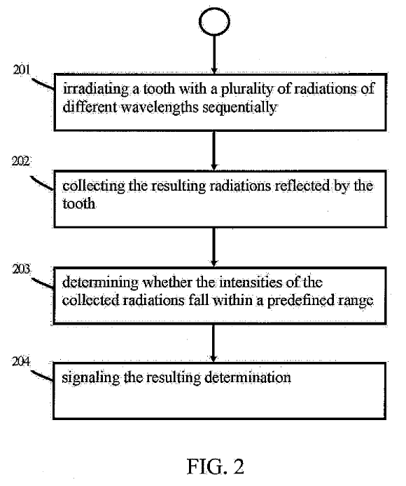

Now, please refer to FIG. 2 for an overall procedure for identifying the optical characteristics of a tooth of the present invention, comprising the following steps:

Step 201: irradiating a tooth with a plurality of radiations of different wavelengths sequentially;

Step 202: collecting the resulting radiations reflected by the tooth;

Step 203: determining whether the intensities of the collected radiations fall within a predefined range; and

Step 204: signaling the resulting determination.

As mentioned above, because a plurality of monochromatic radiations are used in a time differentiation manner, a filtering step is unnecessary between steps 201 and 202 in the method of the present invention, largely enhancing the efficiency of the identification of caries.

It will be understood that many other modifications can be made to the various disclosed embodiments without departing from the spirit and scope of the invention. For this reason, the above description should not be construed as limiting the invention, but should be interpreted as merely exemplary of preferred embodiments.

What is claimed is:

1. A device for identifying an optical characteristic of a tooth, comprising:
a light source for sequentially emitting a plurality of radiations of different wavelengths;
an optical conductor for conducting the radiations onto the tooth;
a sensor for collecting radiations reflected by the tooth;
a comparator for determining whether the intensities of the collected radiations fall within a predefined range; and
an indicator for signaling the resulting determination.

2. The device as claimed in claim 1, wherein the light source is a light emitting diode.

3. The device as claimed in claim 2, wherein the light source is an RGB light emitting diode.

4. The device as claimed in claim 1, wherein the light source emits three radiations of different wavelengths.

5. The device as claimed in claim 1, further comprising a reflection mask for redirecting the radiations emitted by the light source.

6. The device as claimed in claim 1, wherein the optical conductor comprises an optical fiber.

7. The device as claimed in claim 1, wherein the optical conductor comprises a light guide tube.

8. The device as claimed in claim 1, wherein the sensor is selected from the group consisting of a photodiode, a hototransistor, a Si-Pin photodiode, a photon multiplexer tube, a photoconductive cell, a multi channel photon counter, and an avalanche photodiode.

9. The device as claimed in claim 8, wherein the sensor is a photodiode.

10. The device as claimed in claim 1, wherein the indicator is capable of signaling the determination by means of sound variation.

11. The device as claimed in claim 1, wherein the indicator is capable of signaling the determination by means of light variation.

12. The device as claimed in claim 1, further comprising a memory for storing the reflectance properties of the collected radiations.

13. A method of identifying an optical characteristic of a tooth, comprising:
irradiating a tooth with a plurality of radiations of different wavelengths sequentially;
collecting the resulting radiations reflected by the tooth;
determining whether the intensities of the collected radiations fall within a predefined range of wavelengths; and
signaling the resulting determination.

14. The method as claimed in claim 13, wherein the radiations comprise red, green, and blue lights.

15. The method as claimed in claim 13, wherein the radiations are conveyed via an optical fiber.

16. The method as claimed in claim 13, wherein the collection of the resulting radiations is achieved with a photodiode.

17. The method as claimed in claim 13, wherein the signaling step is conducted by a variation of light.

18. The method as claimed in claim 13, wherein the signaling step is conducted by a variation of sound.

19. A system for identifying an optical characteristic of a tooth, comprising:
a light irradiator for sequentially emitting red, green, and blue lights;
an optical conductor for bringing the lights onto the tooth;
a sensor for collecting radiations reflected by the tooth;
a comparator for determining whether the intensities of the collected radiations fall within a predefined range of wavelengths; and
an indicator for signaling the resulting determination.

20. The system as claimed in claim 19, wherein the sensor is a photodiode.
